(19) United States
(12) Patent Application Publication
(10) Pub. No.: US 2009/0176185 A1
(43) Pub. Date: Jul. 9, 2009

(54) Dental handpiece

(76) Inventor: Leo Chen, Zhuhai (CN)

Correspondence Address: Leo Chen, No. 23 Jishi Road, Ji Da District, Zhuhai, 519015, CN

(21) Appl. No.: 12/006,873

(22) Filed: Jan. 8, 2008

(51) Int. Cl. A61C 3/00

(52) U.S. Cl. 433/29

(57) ABSTRACT

A dental handpiece comprising of: a handle, a probe & camera installed at the front of the handle, a LCD attached to the handle where the LCD is connected to the camera.

### BACKGROUND OF THE INVENTION

This present invention is regarding a dental handpiece.

Dentists using dental handpieces usually need assistance from mouth mirrors and lamps to detect teeth and oral cavity conditions. Many factors inconvenience dentists during the examination, analysis, and treatment process. Factors such as various mouth sizes, different disease locations, the dark and moist mouth environment, bad breath of some patients, the need for patients to open their mouth wide for examination and treatment, and etc. The opening of patients' mouth also leads to patients' discomfort.

### BRIEF SUMMARY OF THE INVENTION

The purpose of this new dental handpiece is to provide a small, convenient, and visually appealing dental utility that includes an embedded high resolution video camera with photographing capabilities, embedded lighting system, and a changeable system for switching between appropriate probes.

This present invention is achieved by below technical schemes:

It's a dental handpiece that includes a handle, a probe, and a camera installed at the front of the handle. The handle is with an build-in LCD connected to the camera.

The camera is surrounded by a water-resistant cover welded ultrasonically.

The top of the water-resistant cover is polished, and its side is brushed.

The camera has a detachable protective cover.

The power and camera control switches are on the handle.

The handle is equipped with an internal wire connecting the camera to an external display.

There is also a remote control controlling the external display.

The handle has a PCB and power supply inside.

The detachable probe is with a fixture mechanism to be attached to and remove from the handle.

The camera also acts as a lighting system. The handle is with a control PCB for the lighting system.

The advantage of this present invention is that it is equipped with a camera system, lighting system, and data output system. When the front of the equipment enters the dark and moist mouth, the dentist do not need to check with mouth mirror and lamp nor to stand the bad breath any more during the examination. The dentist can check disease locations and condition with help from the build-in LCD or the external display/PC connected, and can also capture snapshots of the disease locations for future references. The patients no longer need to open their mouth wide. They only have to open the mouth slightly when needed. Patients can also see their disease locations and conditions from the external LCD/PC on the operation chair, and can assist dentists taking photos with the build-in remote control. The handle is highly water-resistant; its electronic components will not be damaged due to the moist mouth environment. The eco-friendly stainless steel probe/equipment can be detached from the handle and is changeable, which makes it easy for sterilization. There is also an optional, single-use eco-friendly plastic probe/equipment to avoid cross infection. The single-use water-resistant camera protective cover can also prevent cross infection. The whole product set comes with a simple, practical, and visually-appealing tool box.

### BRIEF DESCRIPTION OF THE DRAWINGS

In FIG. 1 are diagrams of the detachable structure of the handpiece for this present invention. FIG. 1-1 is a simplified top-view of the probe/equipment and the handle assembled. FIG. 1-2 is a diagram of the probe and the handle (separated). FIG. 1-3 is a diagram of the probe and the handle at use (the probe installed on the handle).

In FIG. 2 are diagrams of the tower-shape video camera system, the photo camera system, the lighting system, and the enlarged picture of the water-resistant set. FIG. 2-1 is a enlarged diagram of the tower structure of the water-resistant set, the lighting system, and the high resolution camera. FIG. 2-2 is a diagram of the build-in remote-control. FIG. 2-3 is a diagram of the assembled camera system and data output system.

In FIG. 3 are diagrams of the assembled single-use, water-resistant camera protective cover. FIG. 3-1 illustrates the shape structure of the single-use, water-resistant camera protective cover. FIG. 3-2 illustrates the single-use, water-resistant camera protective cover and the handle assembled.

FIG. 4 is a diagram of the equipment and the tool box of this present invention.

The copyright of the above figures and all other patents belong to the patent applicant.

### DETAILED DESCRIPTION OF THE INVENTION

Below are the specific detail descriptions of the present invention.

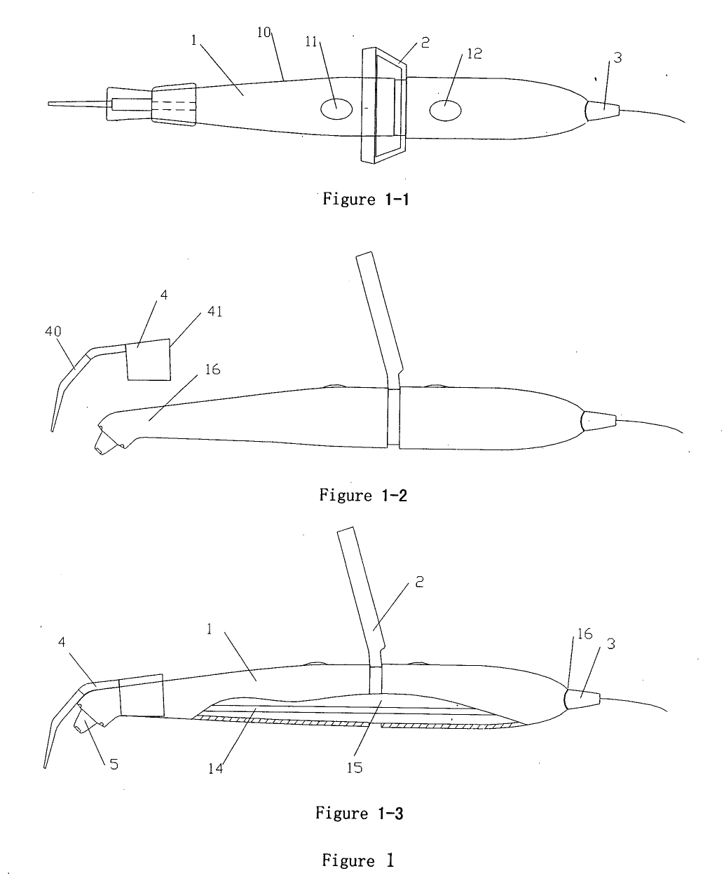

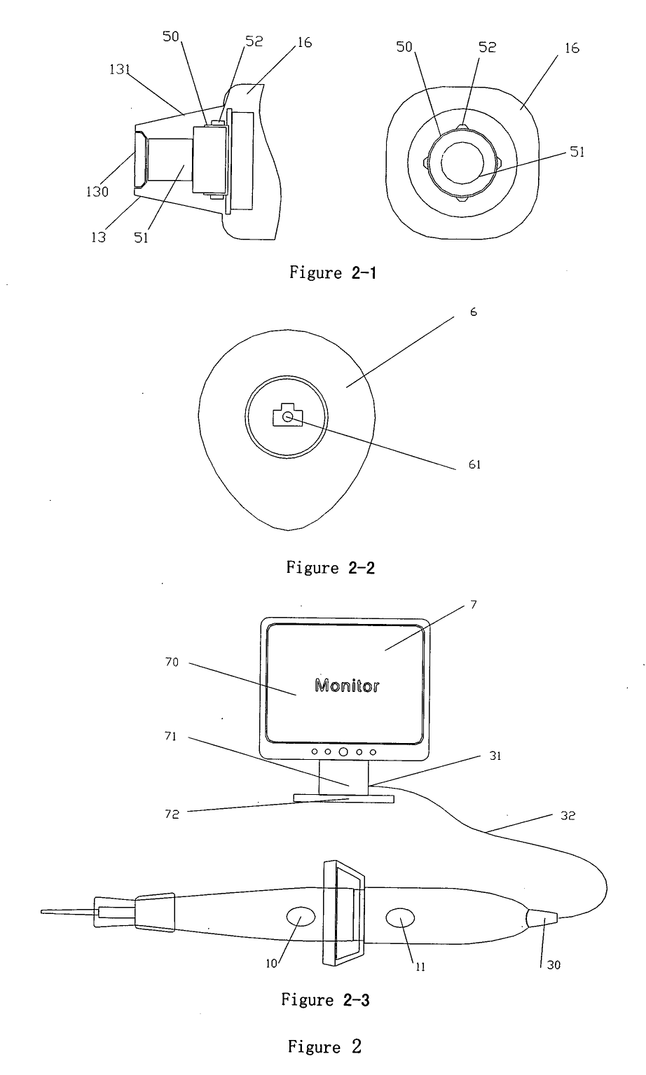

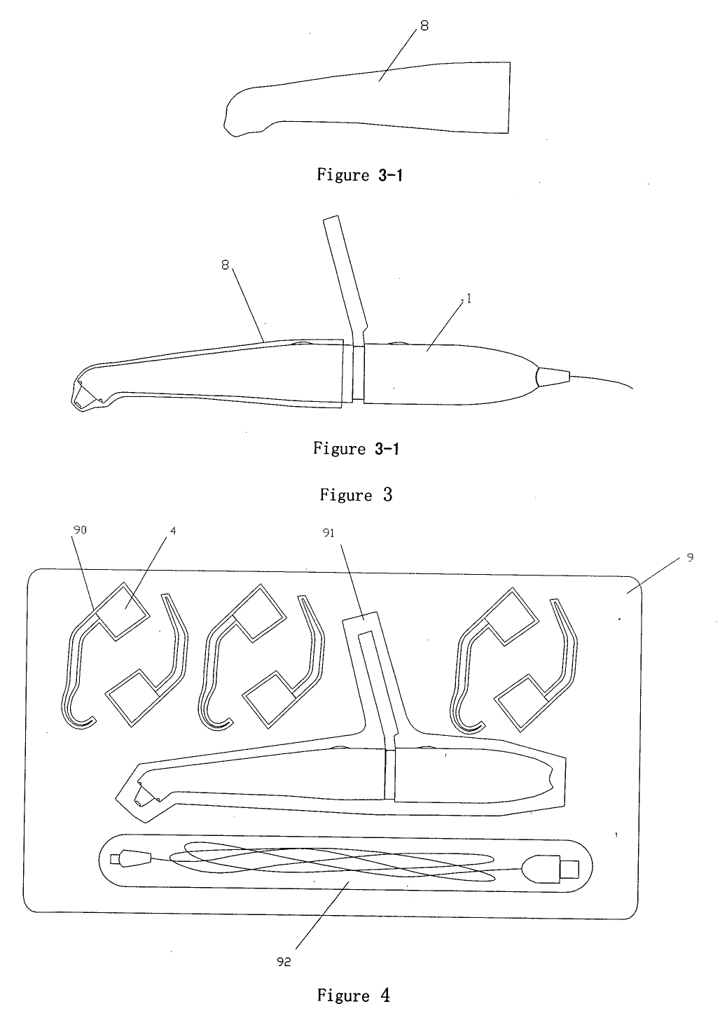

As FIGS. 1, 2 & 3 shows, this present invention includes an equipment handle (FIG. 1), build-in LCD (FIG. 2), USB cable (FIG. 3), Probe/equipment (FIG. 4), camera & lighting system (FIG. 5), build-in remote control (FIG. 6), external LCD/PC (FIG. 7), single-use camera protective cover (FIG. 8), and tool box (FIG. 9). The equipment handle (FIG. 1) includes a handle (FIG. 10), camera switch (FIG. 11), power switch (FIG. 12), water-resistant cover (FIG. 13), CPU (FIG. 14), and handle chamber (FIG. 15). The USB cable (FIG. 3) includes a data output port (FIG. 30), data input port (FIG. 31), and data cable (FIG. 32). The probe/equipment includes an equipment head (FIG. 40) and detachable fixture mechanism (FIG. 41). The camera & lighting system (FIG. 5) includes a flexible PCB (FIG. 50), a lens (FIG. 51), LEDs (FIG. 52), and a water-resistant cover (FIG. 53). The remote control (FIG. 6) is has a camera switch (FIG. 61) on it. The external LCD (FIG. 7) includes a LCD display (FIG. 70), power supply (FIG. 71), and base (FIG. 72).

FIG. 1-2 shows the initial state of the equipment. FIG. 3-1 shows the shape structure of the single-use camera protective cover. To assemble the device, start with FIG. 1-2, put the single-use camera protective cover (FIG. 8) onto the handle (FIG. 1), and clip the detachable fixture mechanism (FIG. 41) onto the handle front (FIG. 16). The assembly completes as FIG. 1-3. The equipment head (FIG. 40) is detachable to the handle front (FIG. 16) through the detachable fixture mechanism (FIG. 41). The detachable fixture mechanism (FIG. 41) is a standardized; The equipment head (FIG. 40) can be various types of dental equipments; The probe/equipment (FIG. 4) is made of eco-friendly stainless steel or eco-friendly plastic material.

The water-resistant cover (FIG. 13) is welded ultrasonically to the top of the handle (FIG. 1), thus achieving a high quality water-resistant structure. The lens is fixed into the water-resistant structure. The LEDs (FIG. 52) are distributed evenly on the flexible PCB (FIG. 50). The flexible PCB (FIG. 50) wraps around the lens (FIG. 51), and connects to the CPU (FIG. 14). The camera/lighting system (FIG. 5) and the CPU (FIG. 14) are embedded inside the handle chamber (FIG. 15). The build-in LCD (FIG. 2) is installed at the mid section on the handle (FIG. 1). The camera switch (FIG. 11) is on the handle and in front of the build-in LCD (FIG. 2). This construction makes it easier for dentists to take photos during examination. The power switch (FIG. 12) is at the back of the build-in LCD (FIG. 2) controlling the power on/off of the camera & lighting system (FIG. 5). At the end of the handle is the USB port (FIG. 16). The USB cable (FIG. 3) can be connected to the USB port (FIG. 16) of the customized external LCD (FIG. 7) or a PC to transmit the data to the external LCD (FIG. 7). With the base (FIG. 72), the external LCD (FIG. 7) or the PC can be put on a flat table, or can be fixed on a chair, a wall, or anywhere for doctors or patients to look at.

As FIG. 2 shows, the polished visible side of the water-resistant cover (FIG. 130) can ensure high resolution video/photo quality. The side (FIG. 131) is with brush finishing, so to ease brightness from the LEDs (FIG. 52). After receiving the data, the lens (FIG. 51) transmits the data to the build-in LCD (FIG. 2) through CPU (FIG. 14), and to the external LCD/PC (FIG. 7) through the USB cable (FIG. 3). The build-in remote control (FIG. 6) in FIG. 2-2 is controlled by the patient, and the patient looking at the external LCD/PC (FIG. 7) can take photos, and can also assist in taking photos on the dentist's request. The power supply (FIG. 71) installed on the external LCD/PC provides all power needed, and provides power through USB cable to the build-in LCD (FIG. 2), camera & lighting system (FIG. 5).

As FIG. 4 shows, the complete equipment set comes with a simple and practical tool box (FIG. 9), which has a handle space (FIG. 91), various probe/equipment spaces (FIG. 90), and a USB cable space (FIG. 92).

What is claimed is:

1. A dental handpiece comprising of: a handle, a probe & camera installed at the front of the handle, a LCD attached to the handle where the LCD is connected to the camera.

2. A dental handpiece of claim 1 where the camera is welded to a water-resistant cover ultrasonically.

3. A dental handpiece of claim 2 where the top of the water-resistant cover is polished, and the side is brushed.

4. A dental handpiece of claim 3 where the camera's protective cover is detachable.

5. A dental handpiece of claim 4 where the power switch and the camera control switch are on the handle.

6. A dental handpiece of claim 5 where there are cables inside the handle connecting the camera to an external LCD, and that there is a remote control with control switches on it.

7. A dental handpiece of claim 5 where there is a PCB and power supply in the handle.

8. A dental handpiece of claim 1 where each of its fitting probes are with a fixture mechanism to attach and detach to the handle.

9. Any dental handpiece from claim 1 to 8 where the camera head is a lighting system and that there are controlling PCB for the lighting system inside the handle.
